(19) United States
(12) Patent Application Publication
(10) Pub. No.: US 2022/0394979 A1
(43) Pub. Date: Dec. 15, 2022

(54) MULTIPURPOSE DISINFECTION SOLUTIONS

(71) Applicants: Pinnacle Environmental Solutions, LLC, Richmond, TX (US); The Administrators of the Tulane Educational Fund, New Orleans, LA (US)

(72) Inventors: Robert S. Reimers, Houston, TX (US); Yue Xu, Gretna, LA (US); David W. Schnare, Burke, VA (US); Chad Roy, Madisonville, LA (US); John Randall Morgan, Katy, TX (US); Downing E. Wilson, Houston, TX (US)

(21) Appl. No.: 17/838,182

(22) Filed: Jun. 11, 2022

Related U.S. Application Data
(60) Provisional application No. 63/210,462, filed on Jun. 14, 2021.

(51) Int. Cl. A01N 59/00; A01N 33/12; A01N 59/26; A01N 25/30; A01P 1/00

(52) U.S. Cl. CPC A01N 59/00; A01N 33/12; A01N 59/26; A01N 25/30; A01P 1/00

(57) ABSTRACT

The present disclosure describes chemical blends and methods of using those blends for multipurpose environmental disinfection of objects and surfaces. The disclosed chemical blends composition comprising stabilized chlorine dioxide; a quaternary ammonium salt; ammonium phosphate; nonionized ammonia; buffer, surfactant, stabilizer; and water. The composition is configured to inactivate the full range of environmental and pathogenic organisms, including amoeba, bacterial spores, vegetative bacteria, fungi, viruses, parasites (eggs and oocysts) and toxic microbial products.

### CROSS REFERENCE OF RELATED APPLICATION(S)

This application claims the benefit under 35 U.S.C. § 119 of U.S. Provisional Application No. 63/210,462 filed on Jun. 14, 2021, which is hereby incorporated by reference in its entirety.

### TECHNICAL FIELD

The present disclosure relates to antimicrobial compositions used for killing harmful bacteria, viruses, funguses, molds, and the like, and to processes for disinfection of surfaces in heating-ventilation-air conditioning (HVAC) facilities, schools, hospitals, healthcare facilities, residential care facilities, child and adult daycare facilities, homes, buildings, airplanes, and cruise ships, and commercial and industrial establishments, and to disinfect various waste streams, including red bag waste, that necessarily use the antimicrobial compositions described herein.

### BACKGROUND

Health care-associated infections (HAIs or nosocomial infections) are infections people get while they are receiving health care for another condition. HAIs can happen in any health care facility, including hospitals, ambulatory surgical centers, end-stage renal disease facilities, and long-term care facilities.

The United States Centers for Disease Control and Prevention have reported that the annual direct hospital costs of treating healthcare-associated infections in the United States range from $35.7B to $45B. The most frequent nosocomial infections are surgical site infections, hepatitis B virus infections, septicemia, gastroenteritis, hepatitis C virus infections, urinary tract infections, and meningitis. However, non-nosocomial infections are equally problematic. For example, non-nosocomial infections from Clostridium difficile arise at a rate about half that of nosocomial infections, result from exposures outside of health-care facilities in locales such as homes, transient and recreation lodgings, schools, and commercial and industrial facilities. The broader array of microbial agents responsible for these both nosocomial and non-nosocomial infections include Acinetobacter, Burkholderia cepacia, Clostridium difficile, Clostridium sordellii, Enterobacteriaceae, hepatitis B virus, hepatitis C virus, human immunodeficiency virus, influenza viruses, Klebsiella, Staphylococcus aureus, Mycobacterium abscessus, norovirus, Pseudomonas aeruginosa, Staphylococcus aureus, Mycobacterium tuberculosis, vancomycin-intermediate Staphylococcus aureus, vancomycin-resistant Staphylococcus aureus, and vancomycin-resistant Enterococci.

HAIs are significant cause of illness and death, and they can have serious emotional, financial, and medical consequences. At any given time, about 1 in 25 inpatients have an infection related to hospital care. These infections lead to tens of thousands of deaths and cost the U.S. health care system billions of dollars each year (HHS 2020).

The U.S. Department of Health and Human Services (HHS) has identified the reduction of HAIs as an Agency Priority Goal. CDC has identified the following nosocomial infective agents as urgent, serious, or concerning threats. (CDC 2021) The cases and deaths shown in Table 1 are those arising while the patient is in a health care facility and are caused by the microorganisms listed. Additional cases and deaths arise in other residential, commercial, and industrial settings. The disinfection processes described herein are targeted at these microorganisms.

TABLE 1
Biggest Antibiotic Resistance Threats in the United States

| | | Cases | Deaths |
|---|---|---|---|
| Microorganism | Threat | (2017) | (2017) |
| Clostridioides difficile | C. difficile causes life-threatening | 223,90 | 12,900 |
| (C. diff.) | diarrhea and colitis (an inflammation of | | |
| | the colon), mostly in people who have | | |
| | had both recent medical care and | | |
| | antibiotics. | | |
| Methicillin-resistant | S. aureus are common bacteria that | 323,700 | 10,600 |
| Staphylococcus aureus | spread in healthcare facilities and the | | |
| (S. aureus) (MRSA) | community. MRSA can cause difficult- | | |
| | to-treat staph infections because of | | |
| | resistance to some antibiotics. | | |
| ESBL-producing | ESBL-producing Enterobacterales are a | 197,400 | 9,100 |
| Enterobacterales | concern in healthcare settings and the | | |
| | community. They can spread rapidly | | |
| | and cause or complicate infections in | | |
| | healthy people. | | |
| Vancomycin-resistant | Enterococci can cause serious infections | 54,500 | 5,400 |
| Enterococcus (VRE) | for patients in healthcare settings, | | |
| | including bloodstream, surgical site, | | |
| | and urinary tract infections. | | |
| Drug-resistant | S. pneumoniae causes pneumococcal | 900,000 | 3,600 |
| Streptococcus | disease, which can range from ear and | | |
| pneumoniae | sinus infections to pneumonia and | | |
| (S. pneumoniae) | bloodstream infections. | | |
| Multi drug-resistant | P. aeruginosa infections usually occur | 32,600 | 2,700 |
| Pseudomonas | in people with weakened immune | | |
| aeruginosa | systems and can be particularly | | |
| (P. aeruginosa) | dangerous for patients with chronic | | |
| | lung diseases. | | |
| Drug-resistant | Dozens of Candida species-a group of | 34,800 | 1,700 |
| Candida Species | fungi-cause infections, ranging from | | |
| | mild oral and vaginal yeast infections to | | |
| | severe invasive infections. Many are | | |
| | resistant to the antifungals used to treat | | |
| | them. | | |
| Carbapenem-resistant | CRE are a major concern for patients in | 13,100 | 1,100 |
| Enterobacterales | healthcare facilities. Some | | |
| (CRE) | Enterobacterales are resistant to nearly | | |
| | all antibiotics, leaving more toxic or | | |
| | less effective treatment options. | | |
| Clindamycin-resistant | GBS can cause severe illness in people | 13,000 | 720 |
| Group B Streptococcus | of all ages. | | |
| Carbapenem-resistant | Cause pneumonia and wound, | 8,500 | 700 |
| Acinetobacter | bloodstream, and urinary tract | | |
| | infections. Nearly all these infections | | |
| | happen in patients who recently | | |
| | received care in a healthcare facility. | | |
| Erythromycin- | GAS can cause many different | 5,400 | 450 |
| resistant Group A | infections that range from minor | | |
| Streptococcus | illnesses to serious and deadly diseases, | | |
| | including strep throat, pneumonia, | | |
| | flesh-eating infections, and sepsis. | | |
| Drug-resistant | TB is caused by the bacteria M. | 847 | 62 |
| Tuberculosis | tuberculosis and is among the most | | |
| | common infectious diseases and a | | |
| | frequent cause of death worldwide. | | |
| Drug-resistant | Shigella spreads in feces through direct | 77,000 | |
| Shigella | contact or through contaminated | | |
| | surfaces, food, or water. Most people | | |
| | with Shigella infections develop | | |
| | diarrhea, fever, and stomach cramps. | | |
| Drug-resistant | C. auris is an emerging multidrug- | 323 | |
| Candida auris | resistant yeast. It can cause severe | | |
| (C. auris) | infections and spread easily between | | |
| | hospitalized patients and nursing home | | |
| | residents. | | |

Clostridium difficile (C. diff) is the most common cause of hospital-acquired infectious diarrhea in the developed world and has re-emerged in recent years with apparent greater morbidity and mortality (Karas J. A. 2010), partly due to the appearance of a hypervirulent strain of the bacterium, North American pulsed-field type 1 NAP1/PCR ribotype 027. This strain has now been detected in Canada, the United States, several European countries, and Australia. C. diff is a major health threat. In 2017, there were an estimated 223,900 cases in hospitalized patients and 12,800 deaths in the United States (CDC 2021) costs up to $4.8 billion each year in excess healthcare costs for acute care facilities alone, causing inflammation of the colon and deadly diarrhea. (Centers for Disease Control, 2015.)

Efforts to use stabilized chlorine dioxide and alkyl dimethyl ethylbenzyl ammonium chloride (without ammonia) have been demonstrated to be ineffective as mentioned in U.S. Pat. No. 4,073,888.

The disinfection formulation disclosed herein will destroy Clostridium difficile and the other nosocomial microorganisms. Unlike all other disinfectants stating they are effective against C. diff the disclosed formulation is not cytotoxic or corrosive. Other than this disclosure, there are no disinfectant patents or patent applications (CPC/A61L and CPC/A01N) that specifically claim effective against C. diff. This disclosure offers a process to directly reduce nosocomial infection illnesses and deaths.

### BRIEF SUMMARY OF THE INVENTION

Disclosed herein are embodiments of antimicrobial compositions and application methods of disinfection using the presently disclosed compositions broadly effective against multiple microbial pathogens.

Disclosed herein are embodiments of antimicrobial compositions and methods for use in disinfecting hard and soft surfaces and necessarily comprising (a) stabilized chlorine dioxide; (b) a quaternary ammonium salt; (c) ammonium phosphate; (d) nonionized ammonia; and (e) water; and alternative means of application of the disclosed antimicrobial compositions.

In some embodiments, the stabilized chlorine dioxide is present in an amount ranging from about 0.2% to about 10.0% (w/w). In some embodiments, the quaternary ammonium salt comprises a C12 or C14 alkyl chain. In some embodiments, the quaternary ammonium salt is C12-C14-alkyl (ethylbenzyl) dimethyl ammonium chloride. In some embodiments, the C12-C14 alkyl (ethylbenzyl) dimethyl ammonium chloride is present in an amount ranging from about 0.1% to about 10.0% (w/w). In some embodiments, the ammonium phosphate or ammonium chloride is present in an amount ranging from about 2.0% to about 20.0% (w/w). In an embodiment, the nonionized ammonia is present in an amount ranging from about 0.2% to about 2.0% (w/w). In some embodiments, the composition further comprises a carbonate buffer to maintain the pH between about 7 and about 8.5 and eliminate corrosivity.

An embodiment relates to a composition comprising: stabilized chlorine dioxide; a quaternary ammonium salt; ammonium phosphate; nonionized ammonia; buffer, surfactant, stabilizer; and water; wherein the composition is configured to be used as a disinfecting solution.

In an embodiment, the composition further comprises ammonium chloride.

In an embodiment, the stabilized chlorine dioxide comprises an amount ranging from about 0.2% to about 10.0% (w/w).

In an embodiment, the quaternary ammonium salt comprises a C12 or C14 alkyl chain.

In an embodiment, the C12-C14-alkyl chain comprises C12-C14-alkyl (ethylbenzyl) dimethyl ammonium chloride.

In an embodiment, the C12-C14-alkyl (ethylbenzyl) dimethyl ammonium chloride comprises an amount ranging from about 0.5% to about 10% (w/w).

In an embodiment, the quaternary ammonium salt is not dodecyl dimethyl ammonium chloride, alkyl dimethyl benzyl ammonium chloride or benzalkonium chloride.

In an embodiment, the ammonium phosphate comprises an amount ranging from about 2.0% to about 20.0% (w/w).

In an embodiment, the ammonium chloride comprises an amount ranging from about 2.0% to about 20.0% (w/w).

In an embodiment, the ammonium phosphate in the composition having a pH of 7.4 dissociates to produce 1% of non-ionized ammonia.

In an embodiment, the ammonium chloride in the composition having a pH of 7.4 dissociates to produce 1% of non-ionized ammonia.

In an embodiment, the ammonium phosphate in the composition having a pH of 8.4 dissociates to produce 10% of non-ionized ammonia.

In an embodiment, the ammonium chloride in the composition having a pH of 8.4 dissociates to produce 10% of non-ionized ammonia.

In an embodiment, nonionized ammonia comprises an amount ranging from about 0.02% to about 2.0% (w/w).

In an embodiment, the buffer comprises sodium bicarbonate to maintain the pH of the composition between about 7.0 and about 8.5.

In an embodiment, the pH of the composition is about 8.5.

In an embodiment, the stabilizer comprises sodium chloride in a concentration of about 6.5 g/L and potassium chloride in a concentration of about 2.5 g/L.

In an embodiment, the surfactant comprises ethylenediamine ethoxylated propoxylated polymer in an amount of from about 1 g/L to about 4 g/L.

In an embodiment, the surfactant comprises ethylenediamine ethoxylated propoxylated polymer in an amount of 2.5 g/L.

In an embodiment, the composition possesses a disinfectant property of about six logs (99.9999%) against bacteria, virus, fungus, protozoa, microbial spores and non-chordata especially helminths and their eggs.

In an embodiment, the composition possesses a disinfectant property of about six logs (99.9999%) against Clostridioides difficile (C. difficile).

In an embodiment, an article disinfected with the composition retains the disinfectant property for about 2 weeks to 4 months.

In an embodiment, the article comprises heating-ventilation-air-conditioning (HVAC) facility, school, hospital, healthcare facility, residential care facilities, child and adult daycare facilities, homes, buildings, airplanes, cruise ships, commercial and industrial establishments, or in detergents.

In an embodiment, the composition is configured to be used in the detergent at a concentration of about 200 to 10,000 mg/l.

In an embodiment, the composition is applied as a spray, a wipe, a fume, and a fog.

In an embodiment, the composition is applied as electrostatic fogging.

An embodiment relates to a composition comprises: stabilized chlorine comprises in an amount of 0.2% to about 10.0% (w/w); a quaternary ammonium salt comprises in an amount ranging from about 0.5% to about 10% (w/w); ammonium phosphate comprises in an amount of about 2.0% to about 20% (w/w); nonionized ammonia comprises in an amount of about 0.02% to about 2.0% (w/w); buffer comprises sodium bicarbonate to maintain pH between 7.0 to 8.5; surfactant comprises in ethylenediamine ethoxylated propoxylated polymer in an amount of about 1 g/L to about 4 g/L; stabilizer comprises in an amount of 2 g/L to 10 g/L; and water; wherein net amount of the non-ionized ammonia is 0.02% to about 12% (w/w).

An embodiment relates to a method of disinfection comprising using an environmental disinfecting composition comprising: (a) stabilized chlorine dioxide solution; (b) a quaternary ammonium salt, consisting of C12-C14-alkyl(ethylbenzyl)dimethylammonium chloride; (c) ammonium phosphate having a formula of (NH4)3PO4; (d) non-ionized ammonia; and (e) buffer, stabilizer, surfactant; wherein the C12-C14-alkyl(ethylbenzyl)dimethylammonium chloride is present in an amount ranging from about 0.1% to about 10% (w/w).

In an embodiment, the environmental disinfecting composition possesses a disinfectant property of about six logs (99.9999%) against bacteria, viruses, fungus, protozoa, microbial spores and non-chordata especially helminths and their eggs.

In an embodiment, the environmental disinfecting composition possesses a disinfectant property of about six logs (99.9999%) against Clostridioides difficile (C. difficile).

In an embodiment, an application of the environmental disinfecting composition comprises fogging, spraying and/or wiping.

In an embodiment, an article disinfected with the environmental disinfecting composition retains the disinfectant property for about 2 weeks to 4 months.

In an embodiment, the article comprises heating-ventilation-air-conditioning (HVAC) facility, instruments for healthcare facility, residential care facilities, child and adult daycare facilities, airplanes, cruise ships, commercial and industrial establishments, or in detergents.

In an embodiment, the environmental disinfecting composition is configured to be used in the detergent at a concentration of about 200 to 10,000 mg/l.

In some embodiments, the stabilized chlorine dioxide is present in an amount ranging from about 0.2% to about 10.0% (w/w). In some embodiments, the quaternary ammonium salt comprises a C12 or C14 alkyl chain.

In some embodiments, the quaternary ammonium salt is C12-C14-alkyl (ethylbenzyl) dimethyl ammonium chloride. In some embodiments, the C12-C14 alkyl (ethylbenzyl) dimethyl ammonium chloride is present in an amount ranging from about 0.1% to about 10.0% (w/w). In some embodiment, minimum concentration of formula C12-C14-alkyl (ethylbenzyl) dimethyl ammonium chloride is 0.5% w/w.

In some embodiments, the ammonium phosphate or ammonium chloride is present in an amount ranging from about 2.0% to about 20.0% (w/w). In an embodiment, the nonionized ammonia is present in an amount ranging from about 0.2% to about 2.0% (w/w). In some embodiments, the composition further comprises a carbonate buffer to maintain the pH between about 7 and about 8.5 and eliminate corrosivity.

Other objects and advantages of this disclosure will become readily apparent from the ensuing description.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a chart documenting the increased spore reduction with increased spore density showing that the greater the level of microbial contamination, the greater the level of disinfection achieved by the disinfectant embodiment.

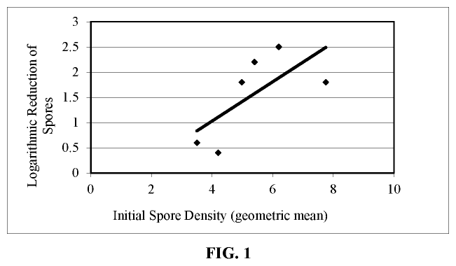

### DETAILED DESCRIPTON

For simplicity and clarity of illustration, the drawing FIGURES illustrate the general manner of construction, and descriptions and details of well-known features and techniques may be omitted to avoid unnecessarily obscuring the present disclosure. Additionally, elements in the drawing FIGURES are not necessarily drawn to scale. For example, the dimensions of some of the elements in the FIGURES may be exaggerated relative to other elements to help improve understanding of embodiments of the present disclosure.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

The present invention may be embodied in other specific forms without departing from its spirit or characteristics. The embodiments described are to be considered in all respects only as illustrative and not restrictive. The scope of the invention is, therefore, indicated by the appended claims rather than by the foregoing description. All changes which come within the meaning and range of equivalency of the claims are to be embraced within their scope.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

While certain novel features of this disclosure shown and described below are pointed out in the claims, the disclosure is not intended to be limited to the details specified, since a person of ordinary skill in the relevant art will understand that various omissions, modifications, substitutions and changes in the forms and details of the disclosure illustrated and, in its operation, may be made without departing in any way from the spirit of the present disclosure. No feature of the disclosure is critical, essential, or necessary unless it is expressly stated as being “critical,” “essential,” “necessary” or “necessarily.” Wherever the phrase “for example,” “such as,” “including” and the like are used herein, the phrase “and without limitation” is understood to follow unless explicitly stated otherwise. Similarly, “an example,” “exemplary” and the like are understood to be non-limiting.

The term “substantially” allows for deviations from the descriptor that don't negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.”

The terms “comprising” and “including” and “having” and “involving” (and similarly “comprises”, “includes,” “has,” and “involves”) and the like are used interchangeably and have the same meaning.

Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b, and c.

Some embodiments of the Multipurpose disinfection solutions (MPDS) disclosed herein contain either three or four active disinfection components with disinfecting qualities and distinct mechanisms of action for microbial killing and/or deactivation. To achieve significant disinfection, numerous types of microorganisms, such as bacteria, spore formers, fungi/yeasts, protozoa, helminths/helminth eggs, and viruses, spanning multiple Kingdoms, are presumed to be encountered. Thus, a combination of chemicals selected for disinfection must possess multiple mechanisms of disinfection in order to completely disinfect and sterilize all possible components of contamination.

Unless otherwise defined herein, scientific, and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

Essential Disinfectant Composition

Multipurpose disinfection solutions (MPDS) are the most widely used cleaners and disinfectants worldwide. These products are typically composed of a single solution for disinfection in various environmental settings, yet this approach has proven to be infective. The majority of commercially available MPDS currently use the same active ingredient disinfectant, organic salts of biguanide-based antimicrobials, at equivalent concentrations in their formulations, making it easier for these products to receive Federal approval at low cost. However, this provides limited disinfection across the microbial spectrum and increases the potential for unwanted microbial growth on surfaces.

Some MPDS contain an additional disinfecting agent, quaternary ammonium (Polyquad), at very low concentrations. Biguanides contain cationic active sites that facilitate cellular lysis through bacteria cell wall interaction, while the addition of an ammonium-based chemical increases the stress upon the diverse microbial constituents that a MPDS is required to kill and/or deactivate.

An optimized disinfecting composition would preferably have broad spectrum antimicrobial activity and relatively low cytotoxicity. The compositions disclosed herein incorporate multiple chemical class microbial stressors to reduce microbial burden by direct killing and/or deactivation. Different ingredients are used for different groups of infective agents and pathogens, applying the concept of incorporating multiple stressors to achieve disinfection.

Disclosed herein is an environmental disinfecting composition that necessarily uses the disclosed disinfecting compositions. An embodiment of the present disinfecting composition consists of (a) stabilized chlorine dioxide; (b) a quaternary ammonium salt; (c) ammonium phosphate or ammonium chloride; (d) nonionized ammonia; and (e) water.

As used herein “stabilized chlorine dioxide” or “SCD” refers to an aqueous sodium chlorite (NaClO2) solution.

In some embodiments, stabilized chlorine dioxide is prepared by buffering sodium chlorite with a carbonate or a phosphate, and hydrogen peroxide. In addition to sodium chlorite, stabilized chlorine dioxide may further comprise sodium chlorate (NaClO3) and sodium chloride (NaCl). In some embodiments and under the right pH condition stabilized chlorine dioxide may further comprise chlorine dioxide (ClO2).

In some embodiments, the composition described herein comprises stabilized chlorine dioxide as a source of sodium chlorite.

In some embodiments, the stabilized chlorine dioxide is present in an amount ranging from about 0.2% to about 10.0% (w/w), with additional lower and/or upper limits of the amount being 0.3% (w/w), 0.4% (w/w), 0.5% (w/w), 0.7% (w/w), 0.9% (w/w).

In some embodiments, sodium chlorite is present in the composition in an amount ranging from about 0.0001% to about 01.0% (w/w), with additional lower and/or upper limits of the amount being 0.005% (w/w), 0.05% (w/w), 0.5% (w/w).

In some embodiments, the oxychlorine-based component of the composition described herein (e.g., sodium chlorite, stabilized chlorine dioxide, or chlorine dioxide) inhibits the cellular protein synthesis. In some embodiments, the oxychlorine-based component of the composition described herein (e.g., sodium chlorite, stabilized chlorine dioxide, or chlorine dioxide) inhibits the destruction of disulfide bonds.

As used herein “quaternary ammonium cations” also known as quats, refer to positively charged polyatomic ions of the structure NR4+, R being an alkyl group or an aryl group. Unlike the ammonium ion (NH4+) and the primary, secondary, or tertiary ammonium cations, the quaternary ammonium cations are permanently charged, independent of the pH of their solution. Quaternary ammonium salts or quaternary ammonium compounds are salts of quaternary ammonium cations.

In some embodiments, the composition described herein comprises a quaternary ammonium salt. In some embodiments, the quaternary ammonium salt comprises a C12 or C14 alkyl chain. In some embodiments, the quaternary ammonium salt is not benzalkonium chloride. In some embodiments, the quaternary ammonium salt is C12-C14-alkyl (ethylbenzyl) dimethyl ammonium chloride.

In some embodiments, the quaternary ammonium salt, is present in the composition in an amount ranging from about 0.1% to about 10.0% (w/w), with additional lower and/or upper limits of the amount being 0.5.0% (w/w), 1.0% (w/w), 1.5.0% (w/w), 3.0% (w/w), 5.0% (w/w), 7.0% (w/w).

In some embodiments, the quaternary ammonium salt destroys phospholipids within the microbial cell wall, prompting autolysis, and microbial cell entry for the oxychlorine-based component in the formulation (e.g., sodium chlorite, stabilized chlorine dioxide, or chlorine dioxide).

As used herein “ammonium phosphate” refers to ammonium phosphate dibasic. In some embodiments, the composition described herein comprises ammonium phosphate.

In an embodiment, the ammonium phosphate is present in the composition in an amount ranging from about 2.0% to about 20.0% (w/w), with additional lower and/or upper limits of the amount being 5.0% (w/w), 10.0% (w/w), 15.0% (w/w) and will dissociate into an ionic phosphate and nonionized ammonia.

In some embodiments, ammonium phosphate enhances the effectiveness for autolysis on hard-to-kill Gram-bacteria and spore formers, fungi, and recalcitrant organisms such as pathogenic amoeba and C. diff.

As used herein “non-ionized ammonia” refers to ammonia in un-ionized form, having the formula NH3. In ionized, form, it has the formula NH4+i.e., as an ammonium ion The major factor that determines the proportion of ammonia or ammonium in a solution is pH of the solution. The proportion of ammonia and ammonium ions is also influenced by temperature and ionic strength of the solution. In an embodiment, the composition in the present disclosure comprises non-ionized ammonia. In another embodiment, the amount of non-ionized amount varies from about 0.02% to about 5.0% (w/w), with the additional lower and upper limit being 0.05% (w/w), 1.0% (w/w), 2.0% (w/w), 3.0% (w/w), 4.0% (w/w).

As used herein “buffer” refers to a combination of weak acid and its conjugate base or a weak base and its conjugate acid, to keep the pH of a solution within a narrow range. E.g., Acetic acid, citric acid, monopotassium phosphate, boric acid, sodium bicarbonate along with their salts can act as a buffer in a solution. In an embodiment, sodium bicarbonate is the compound to act as a buffer in the composition. In an embodiment, buffer maintained the pH of the composition between 6.0 to 9.0. In an embodiment, the disinfection composition further comprises a buffer to maintain the pH between about 6.2 and about 8.5 and can take a value anywhere within that range. In some embodiments of the disinfecting composition, the buffer is a phosphate buffer. In some embodiments of the disinfecting composition, the buffer is a carbonate buffer.

As used herein “surfactant” refers to compounds that lower the surface tension, thereby increasing its spreading and wetting properties, between two liquids, between a gas and a liquid, or between a liquid and a solid. Surfactants may act as detergents, surface-active agent, wetting agents, emulsifiers, foaming agents, or dispersants.

In an embodiment, surfactants are selected from cationic surfactants, nonionic surfactants, and anionic surfactants. In another embodiment, surfactant is ethylenediamine ethoxylated propoxylated polymer.

In an embodiment of the disinfecting composition, the composition further comprises a non-ionic surfactant. In some embodiments of the disinfecting composition, the non-ionic surfactant comprises a block copolymer. In some embodiments of the disinfecting composition, the block copolymer is an ethylenediamine ethoxylated propoxylated polymer. In an embodiment of the disinfecting composition, the non-ionic surfactant is present in the composition in an amount of less than about 10% and may take any value below that amount.

In an embodiment, the amount of surfactant varies from 0.5 g/L, 1 g/L, 1.5 g/L and so on. In yet another embodiment, the amount of surfactant in the composition is 4 g/L.

As used herein “stabilizer” refers to the substances that increase stability and thickness by helping ingredients remain in an emulsion and retain physical characteristics. Examples of stabilizer but not limited to are, inulin, sodium alginate, sodium carboxymethyl cellulose (CMC), guar gum, locust bean gum, sodium chloride, potassium chloride, carrageenan, gelatin, and pectin.

In an embodiment, the amount of stabilizer varies from 1.0 g/L to 10 g/L, with additional lower and upper limit being selected from 2.0 g/L, 5.0 g/L. In an embodiment, sodium chloride is in a concentration of about 6.5 g/L and potassium chloride is in a concentration of about 2.5 g/L.

As used herein “ammonium chloride” refers to an inorganic compound with the formula NH4Cl and a white crystalline salt that is soluble in water.

As used herein “dissociates” refers to the breaking up of a compound into simpler constituents that are usually capable of recombining under other conditions. In an embodiment, ammonium phosphate will dissociate into ionic phosphate and nonionized ammonia.

As used herein “disinfecting solution” refers to a solution used to control, prevent, or destroy harmful microorganisms (i.e., bacteria, viruses, or fungi), non-chordata or lower chordata, inanimate objects and surfaces. Disinfecting solution comprising disinfecting agents which are registered by the Environmental Protection Agency (EPA) as “antimicrobial pesticides.”

As used herein “disinfecting property” refers to the property of the disinfecting solution or agent to cleanse the infection. A disinfecting solution or agent having good disinfecting property includes broad spectrum action against microbes and other small organisms, fast acting, not affected by environmental factors and compatible with soaps, detergents, and other chemicals encountered in use, nontoxic to the user or patient, surface compatibility, residual effect on treated surfaces i.e., should leave an antimicrobial film on the treated surface. In an embodiment, the disinfecting property of the composition is about 2 weeks to 4 months.

As used herein “six logs” refers to up to six digits. Numeric term “log” refers to log 10. Here, the disinfecting property of the composition is approximately 6 logs or more. In an embodiment, six logs refer to 99.9999%.

In some embodiments, the stabilized chlorine dioxide is present in an amount ranging from about 0.2% to about 10.0% (w/w). In some embodiments, the quaternary ammonium salt comprises C12 or C14 alkyl chain. The quaternary ammonium salt can take the form of C12-C14-alkyl (ethylbenzyl) dimethyl ammonium chloride. In some embodiments, the C12-C14-alkyl (ethylbenzyl) dimethyl ammonium chloride is present in an amount ranging from about 0.1% to about 10.0% (w/w). In some embodiments, the ammonium phosphate or ammonium chloride is present in an amount ranging from about 2.0% to about 20.0% (w/w). In some embodiments, the nonionized ammonia is present in an amount ranging from about 0.2% to about 2.0% (w/w).

Other embodiments of the disinfecting composition may be at an increased level of stabilized chlorine dioxide, quaternary ammonium salts, ammonium phosphate, and nonionized ammonia if, for example, it is used as an ingredient in a detergent, or otherwise needed to disinfect highly contaminated surfaces.

In some embodiments of the disinfecting composition, the composition further comprises tonicity agents. Non-limiting examples of tonicity agents are sodium chloride and potassium chloride. In an embodiment of the disinfecting composition, the tonicity agent is present in the composition in an amount of less than about 1% (w/w) and may take any value below that amount.

In an embodiment of the disinfecting composition, the stabilized water is not corrosive or scaling.

In an embodiment of the disinfecting composition, the oxidation-reduction potential (ORP) of the composition is between about −70 and about −90 my.

In an embodiment, the disinfectant and disinfecting processes disclosed herein are capable of disinfecting hard and soft surfaces. In some embodiments, the hard and soft surfaces may be in the form of an object such as toys or pillows.

One embodiment of the disinfecting composition may take the form consisting of: quaternary ammonia, (0.1%), ammonium phosphate dibasic (2%) and stabilized chlorine dioxide (0.2%) to treat and disinfect bacteria, viruses, protozoans, and helminth eggs, etc.

In an embodiment of the formulation pH level is of 7.0 to 8.4, allowing its applicability in public buildings, schools, and hospitals without concerns over property damage, damage to electronic equipment or adverse effects on humans. Table 2 presents one embodiment of the formulation disclosed herein.

TABLE 2
Summary of Ingredients and Efficacy of the Disinfection Composition

| Ingredient | Concentrations | Degree of Inactivation |
|---|---|---|
| Chlorine Dioxide | Stabilized ClO₂ 2,000 mg/L | 9 log reduction of bacteria and 6 |
| | ClO₂ 100-200 mg/L NaClO₂ | log reduction, of virus in |
| | 1900-1800 mg/L | municipal sludge |
| | Neutralizer Process ClO₂ 125 | |
| | mg/l | |
| Quaternary Amines | C12-C14 alkyl(ethylbenzyl) | 9 log reduction of bacteria |
| | dimethylammonium chloride | 6 log reduction, of virus |
| | 5 g/L | |
| Ammonium Phosphate/ | 20,000 mg/L of (NH₄)₂HPO4 | 6 log reduction of parasites and |
| Nonionized Ammonia | At pH of 7.4 NH₃ = 30 mg/L | protozoan |
| | At pH of 8.4 NH₃ = 300 mg/L | oocysts |
| | Non-charged disinfectant | |
| Buffers | Phosphate Buffer (100 mM) at | The buffer controls the NH3 |
| | a pH of 7.4 or | concentrations |
| | Na₂HPO₄ = 12.7 g/L | |
| | NaH₂PO₄ = 3.2 g/L | |
| | Carbonate Buffer (100 mM) at | |
| | a pH of 8.4 | |
| | Na₂HCO3 = 9.0 g/L | |
| Ionic Strength | NaCl = 6.5 g/L and KCl = 2.5 | Gives blend conductivity to |
| | gL | control corrosion. |
| Surfactant | Tetronic 2.5 g/L | Osmolarity 3000 |

Disinfection Process

There are numerous areas that may benefit from improved means of disinfection, including any space within which persons at risk may use. The disinfection composition may be used in schools, hospitals, healthcare facilities, residential care facilities, child and adult daycare facilities, homes, buildings, industrial workspaces, airplanes, cruise ships, commercial and industrial setting and on regulated medical (red bag) waste.

In an embodiment, the disinfecting composition described herein is not used for water treatment purposes. In an embodiment, the disinfecting composition described herein is not used in pulp bleaching. In an embodiment, the disinfecting composition described herein is not used on medical devices.

When dispensing an embodiment of the disinfection composition disclosed herein in an intended and suitable form, the disinfecting solution may be dispensed in a variety of ways depending on the intended use and environment. Such dispensing may include, without limitation, by spray, wipe, electrostatic spray, electrostatic fogging, room fogging, as an additive to soft surface detergents, or using a disinfectant bath, in each case it being essential to use an embodiment of the disinfectant solution disclosed herein. The disinfection composition disclosed herein may be dispensed as a spray utilizing any suitable spraying means, such as a spray bottle, sprinkler, spray nozzle, or the like. The disinfection composition disclosed herein may be dispensed as a fog utilizing any suitable fogging means, such as an ultra-low volume mechanical fogging apparatus, or an ultra-low volume mechanical fogging apparatus that introduces an electrical charge to each droplet (electrostatic fogger) as described herein. The disinfection composition disclosed herein may be dispensed as a wipe utilizing any suitable fabric that might be used to otherwise dust or adsorb spills or any similar material.

In some embodiments, blood and other body fluids must be thoroughly cleaned from surfaces and objects before application of this product. An embodiment of the disinfection composition described herein is not intended to be used to disinfect critical or semi-critical medical devices prior to sterilization or high-level disinfection. An embodiment of the disinfectant solution described herein is not to be used as a terminal sterilant/high level disinfectant on any surface of instrument that (1) is introduced directly into the human body, either into or in contact with the bloodstream or normally sterile areas of the body, or (2) contact intact mucous membranes but which does not ordinarily penetrate the blood barrier or otherwise enter normally sterile areas of the body.

In some embodiments, disinfection is accomplished through pre-cleaning with or without using an embodiment of the disinfection composition described herein. In some embodiments, pre-cleaning is accomplished by removing visible soil by spraying an embodiment of the disinfectant solution described herein straight onto soils, followed by scrubbing and wiping clean with a dry paper towel or cloth. In some embodiments, when used as a pre-cleaner an embodiment of the disinfectant solution described herein can be a light even coating of an embodiment of the disinfectant solution described herein can be sprayed over the soiled area until wet and then allow to remain wet for 60 minutes.

In some embodiments, disinfection of electronic equipment is through electrostatic spraying or fogging, using an embodiment of the disinfection composition described herein.

In some embodiments, disinfection of surfaces is through spraying or fogging the surfaces until lightly wetted using an embodiment of the disinfection composition described herein. In other embodiments, disinfection of fabrics, clothing, bedding, pillows, and the like is accomplished through routine washing where an embodiment of the disinfection composition disclosed herein is added to the wash water with the detergent. In some embodiments, two cups or less of an embodiment of the disinfection composition disclosed herein is added to the wash water.

In some embodiments, disinfection of rooms and corridors, or the like, is accomplished using a mobile electrostatic sprayer or electrostatic fogger, or a stationary room fogger and using an embodiment of the disinfection composition disclosed herein. In some embodiments, disinfection of a room is accomplished by applying an embodiment of the disinfection composition disclosed herein in a manner that applies a light coating to all surfaces in the room, including surfaces of all equipment, furniture, or the like.

In some embodiments, disinfection of the surfaces of corridors, hallways and the like are accomplished using an embodiment of the disinfection composition disclosed herein by spraying, electrostatic spraying, or fogging, or through addition of an embodiment of the disinfection composition disclosed herein to the cleaning solution used to mop the floors.

When disinfecting a surface with the disinfection composition disclosed herein by allowing the disinfecting composition to remain on the surface for at least five (5) to ten (10) minutes, or as required to disinfect the surface or comply with appropriate regulations, the disinfecting composition is allowed to remain on the surface, tool, instrument, or equipment for any amount of time required to disinfect the surface. Such a time may be dictated by appropriate statute or may be the time necessary to complete disinfection as desired.

Moreover, the disinfection composition disclosed herein may be removed from the surface, but the disinfecting solution does not need to be removed in every instance. For example, disinfecting solution dispensed as an electrostatic fog may not need to be removed after disinfection. In other embodiments, the disinfecting composition may be removed by rinsing the surface, tool, instrument, or equipment with potable water. In other embodiments, the disinfecting solution may be removed by wiping the surface clean. However, in some embodiments, the disinfection composition may be removed via one or more of the following methods: rinsing, drying, heat drying, wiping, sponging, blotting, rubbing, evaporation, or shaking.

Certain embodiments of the present invention may be used to produce a disinfectant fog. For example, and not by way of limitation, an embodiment of the disinfection composition disclosed herein may be used with an ultra-low volume mechanical fogging apparatus to create small aerosol droplets.

As another example, an embodiment of the disinfection composition disclosed herein may be used with an ultra-low volume mechanical fogging apparatus to create small aerosol droplets and introduce an electrical charge to each droplet. This process may be referred to as electrostatic fogging. When the droplets are charged in such a process there is a two-fold effect. First, the droplets are attracted to surfaces. This allows the droplets to contact surfaces that are otherwise inaccessible to wipes, sprays, or other forms of fog. Second, when the droplets are charged, a synergistic effect is observed between the liquid form of the compound in question and microbes. More specifically, the compound acts to kill microorganisms at a much higher rate if applied using an electrostatic fogger when compared to other ultra-low volume foggers. A synergy is observed when the compound is formulated in a liquid solution then applied using an electrostatic fogger. When an electrical charge is applied to the liquid compound, the compound has a much greater antimicrobial activity against pathogens. Namely, the electrically charged particles act more quickly and more completely to kill pathogens.

In some uses of an embodiment of the disinfection composition disclosed herein, waste materials, including red bag wastes, may be disposed of in a municipal solid waste or industrial waste landfill after being sprayed or electrostatically fogged with the disinfectant composition prior to being shredded, and/or the like, and/or are sprayed or electrostatically fogged during and immediately post shredding, and/or otherwise coated with a spray or electrostatic fogging using an embodiment of the disinfection composition disclosed herein.

In an embodiment, disinfectant solution targets Healthcare-Associated Infections (HAIs), and in particular, Clostridium difficile (C. diff. The US EPA lists sixty-three (63) products as effective against C. diff Of these, forty (40) are bleaches, eighteen (18) are peroxides, and five (5) are free chlorine solutions that are effectively neutral pH bleaches, none contain ammonia (NH₃). Under EPA rules, if any of these formulations include ammonium salts or ammonia as another or “inert” ingredient, they did not expect it to have antimicrobial effect as any ingredient with antimicrobial effect must be listed as an active ingredient.

In an embodiment, the present disclosure extends their knowledge on killing spores in human wastewater sludge to doing so in clinical and residential settings. Although the work on sludges has been ongoing for 25 years, analysis of EPA registered disinfectants has found no one else has added ammonia as an active ingredient in combination with chlorine dioxide and quats.

TABLE 3
Assessment of Present invention with the prior art.

| | | | Vital Oxide (Prior Art |
|---|---|---|---|
| Ingredient | Present invention | Ascepticys (Prior Art 1) | 2 |
| Stabilized | Stabilized 0.2% ClO₂ | Stabilized 0.02% ClO₂ | Stabilized 0.2% ClO₂ |
| Chlorine | (2,000 mg/L) | (187 mg/L) | (2,000 mg/L) |
| Dioxide | ClO₂ 100-200 mg/L | ClO₂ 10 to 20 mg/L | ClO₂ 100-200 mg/L |
| | NaClO₂ 1900-1800 mg/L | NaClO₂ 190-180 mg/L | NaClO₂ |
| | | | 1900-1800 mg/L |
| Quats | C12-C14 | C12-C14 | C12-C14 (0.17%) |
| Ammonium | alkyl(ethylbenzyl) | alkyl(ethylbenzyl) | 0.085% (850 mg/L) |
| Compounds | dimethylammonium | dimethylammonium | Dimethyl Benzyl |
| | chloride | chloride | ammonium chloride |
| | 0.5% (5 g/L) to 0.001% | 0.01% (100 mg/L) | 0.085% (850 mg/L) |
| | (10 mg/L) | to 0.001% (10 mg/L) | Dimethyl ethylbenzyl |
| | 20,000 mg/L of NH₄H₂PO₄ | Ammonium Chloride | ammonium chloride |
| | At pH of 7.4 | 2,000 mg/L of (NH₄)₃Cl | None |
| | NH₃ = 30 mg/L | At pH of 7.4 | |
| | At pH of 8.4 | NH₃ = 20 mg/L | |
| | NH₃ = 300 mg/L | At pH of 8.4 | |
| | Non-charged disinfectant | NH₃ = 200 mg/L | |
| | | Non-charged | |
| | | disinfectant | |
| Buffers | Carbonate Buffer at | Phosphate Buffer at | pH = 8.5 to 8.0 (dilute) |
| | a pH of 8.4 | a pH of 7.4 or | |
| | NaCO₃ = 9.0 g/L | Na₂HPO₄ = 120 mg/L | |
| | | NaH₂PO₄ = 1950 g/L | |
| Ionic | NaCl = 6.5 g/L and | NaCl = 1.0 g/L and | NaCl = 1.0 g/L and |
| Strength | KCl = 2.5 g/L | KCl = 2.5 g/L | KCl = 2.0 g/L |
| Surfactant | Tetronic 1.5 g/L | Tetronic 2.5 g/L | Tetronic 2.5 g/L |
| Others | ORP = 318 mv | EDTA = 500 mg/L | |
| | | Propylene Glycol = 7500 | |
| | | mg/L | |
| | | Osmolarity 260-340 | |

In yet another embodiment, the application of stabilized chlorine dioxide and quaternary amines effectively deactivate viruses by attacking the viral envelope and then the core protein preventing the production of protein and destroying the virus (USEPA Certification, 2020). All three the chlorine dioxide, quaternary amines and ammonia will inactivate the viruses as noted in the literature for municipal sludge, sanitizing surfaces and etc.

The result of using disinfectant solution is shown in Table 4.

TABLE 4
Result of the disinfectant solution of the present invention against viruses.

| | | | |
|---|---|---|---|
| | | Contact | Study |
| Disinfection | Use Method | Time | Conclusion |

Enveloped Viruses

| | | | |
|---|---|---|---|
| Swine Influenza (H1N1)Virus** l | Virucida | 5 min. | Complete |
| | Efficacy | | inactivation |
| Respiratory Syncytial Virus** | Virucidal | 5 min. | Complete |
| | Efficacy | | inactivation |
| Influenza B Virus** | Virucidal | 5 min. | Complete |
| | Efficacy | | inactivation |
| Hepatitis A Virus** | Virucidal | 5 min. | Complete |
| | Efficacy | | inactivation |
| Hepatitis B Virus** | Virucidal | 5 min. | Complete |
| | Efficacy | | inactivation |
| Hepatitis C Virus** | Virucidal | 5 min. | Complete |
| | Efficacy | | inactivation |
| Human Immunodeficiency Virus | Virucidal | 5 min. | Complete |
| (HIV Type 1)** | Efficacy | | inactivation |
| Hantavirus (Prospect Hill Virus) | Virucidal | 5 min. | Complete |
| University of Ontario** | Efficacy | | inactivation |
| Canine Distemper Virus, Strain | Virucidal | 5 min. | Complete |
| Snyder Hill, ATCC VR** | Efficacy | | inactivation |
| Felid Herpesvirus 1, Strain C-27, | Virucidal | 10 min. | Complete |
| ATCC VR-636** | Efficacy | | inactivation |
| Feline coronavirus, Strain WSU | Virucidal | 10 min. | Complete |
| 79-1683, ATCF VR-989** | Efficacy | | inactivation |
| Canine coronavirus, Strain 1-71, | Virucidal | 10 min. | Complete |
| ATCC VR-809** | Efficacy | | inactivation |

Non-Enveloped Viruses

| | | | |
|---|---|---|---|
| Rotavirus | Virucidal | 5 min. | Complete |
| | Efficacy | | inactivation |
| Norovirus Feline CalicivirusJ | Virucidal | 5 min. | Complete |
| | Efficacy | | inactivation |
| Murine Norovirus (MNV-1) | Virucidal | 5 min. | Complete |
| | Efficacy | | inactivation |
| Adenovirus 1, Strain Adenoid 71, | Virucidal | 10 min. | Complete |
| ATCC VR-1 | Efficacy | | inactivation |
| Canine Parvovirus, Strain Cornell- | Virucidal | 10 min. | Complete |
| 780916, ATCC VR-2016 | Efficacy | | inactivation |
| Canine adenovirus 1, Strain | Virucidal | 10 min. | Complete |
| Utrecht, ATCC VR-293 | Efficacy | | inactivation |

In an embodiment, the disinfection of bacteria has been effective with blends of stabilized chlorine dioxide, quaternary amines, and ammonia. The bacteria are inactivated through selective oxidation. Chlorine dioxides attack the proteins in the cell wall by disrupting the protein and then synthesis effectually killing the bacteria by deactivating the DNA. The quats and oxidant will effectively kill both gram-positive and gram-negative bacteria (EPA Certification, 2020). This data is shown in table 5.

TABLE 5
Disinfection effect against bacteria using the disinfection
solution of the present solution

| | | | |
|---|---|---|---|
| | | Contact | Study |
| Disinfection | Use Method | Time | Conclusion |

Gram Negative Bacteria

| | | | |
|---|---|---|---|
| Acinetobacter | AOAC | 10 min. | Disinfection |
| baumannii ATCC | Use-Dilution | | |
| 19606 | | | |
| Pseudomonas | AOAC | 10 min. | Disinfection |
| aeruginosa ATCC | Use-Dilution | | |
| 15442 | | | |
| Salmonella enterica | AOAC | 10 min. | Disinfection |
| ATCC 10708 | Use-Dilution | | |
| Klebsiella | AOAC | 10 min. | Disinfection |
| pneumoniae (NDM- | Use-Dilution | | |
| 1) ATCC BAA-2146 | | | |
| Escherichia coli | AOAC | 10 min. | Disinfection |
| ATCC 11229 | Use-Dilution | | |
| Bordetella | AOAC | 10 min. | Disinfection |
| bronchiseptica | Use-Dilution | | |
| ATCC 10580 | | | |

Gram Positive Bacteria

| | | | |
|---|---|---|---|
| Staphylococcus | AOAC | 10 min. | Disinfection |
| aureus MRSA | Use-Dilution | | |
| ATCC 33592 | | | |
| Staphylococcus | AOAC | 10 min. | Disinfection |
| aureus ATCC 6538 | Use-Dilution | | |
| Listeria | AOAC | 10 min. | Disinfection |
| monocytogenes | Use-Dilution | | |
| ATCC 15313 | | | |
| Mycobacterium | AOAC | 10 min. | Disinfection |
| bovis-BCG | Use-Dilution | | |

In an embodiment, the blends of chlorine dioxide and quats destroys molds and mild. Research has noted that the disinfections of highly resistant black mold due to the chlorine dioxide and the quats enable to keep the surface resistant to mold spores up to seven months. These blends do not damage the surfaces traditional and can penetrate deep into semi-porous surfaces like concrete to kill the root of the problem. Another important point is this blend does not harm plants or the exterior of your home along with not containing volatile organic compounds as noted in table 6.

TABLE 6
Control of fungi on surface using present invention

| | | | |
|---|---|---|---|
| Disinfection | Use Method | Contact Time | Study Conclusion |

Fungi on Surface

| | | | |
|---|---|---|---|
| Aspergillus Niger | Mildewstat | 10 min. | >4 weeks protection |
| ATCC 6275 | | | |
| Trichophyton | Fungicide | 10 min. | No germination of |
| rubrum ATCC MYA | | | spores |
| Trichophyton | Fungicide | 10 min. | No germination of |
| mentagrophytes | | | spores |
| ATCC 9533 | | | |

In an embodiment, using the mister with Vital Oxide containing stabilized chlorine dioxide and quats has a noted potential positive impact in reducing hospital acquired infections by improving coverage with a hospital grade disinfectant. This data reduction was over 90 percent.

In an embodiment, the phenomena apply the concept of multiple stressors. The active ingredients are listed below:

1. Stabilized chlorine dioxide penetrates polysaccharide barrier of the bacteria resulting in protoplasm leakage. The chlorine dioxide will degenerate the DNA, which will inactivate the bacteria and similar results are noted for viruses. The high concentrations of chlorite will assist in oxidizing the bacteria cell walls in gram-negative bacteria and virus deactivation.
2. Quaternary amines (C12-14 Alkyl(ethylbenzyl)dimethylammonium Chloride) is an excellent antimicrobial agent, often used in medical or domestic settings. It inactivates gram-positive bacteria and long-term control of molds and viruses. This is done by disrupting the bacteria cell wall or denaturing the virus DNA.
3 Ammonia is a non-charged biocide for parasites, spores, and oocytes in municipal sludge disinfection. It is the main active ingredient in advanced alkaline stabilization. In alkaline stabilization and disinfection of municipal sludge, it is the free ammonia that has been demonstrated with spore densities of 10⁴ to 10⁵ per gram dry weight and Ascaris egg levels at 10⁴ to 10³ per gram dry weight.

Table 7 indicates the effectiveness of utilizing ammonia in combination with stabilized chlorine dioxide and quats.

TABLE 7
Observed Levels of Sewage Bacteria before and after Treatment (CFU/g)

| | | Fecal | | | Fecal |
|---|---|---|---|---|---|
| Sample | Total Coliform | Coliform | E. coli | Enterococci | Streptococcus |
| Before | 6.3 × 10⁶ | 3.5 × 10³ | 3.5 × 10³ | 0.6 × 10³ | 1.1 × 10³ |
| After | <1.0 × 10⁶ | <1.0 × 10² | <1.0 × 10² | <1.0 × 10² | <1.0 × 10² |
| Detention | <1.0 × 10⁶ | <1.0 × 10² | <1.0 × 10² | <1.0 × 10² | <1.0 × 10² |
| Limit | | | | | |
| Comments | Inactivate to | Inactivated to | Inactivated to | Inactivated to | Inactivated to |
| | about one log | about 1.5 logs | about 1.5 logs | about 1.1 logs | about 1.1 logs |
| | reduction | | | | |

The bacterial levels were below 10³ which is below the level noted for disinfected municipal biosolids.

In an embodiment, microbial resistance to disinfectants has been investigated and it is possible to list the major groups of microorganisms from most to least resistant as follows:
bacterial spores>mycobacteria>parasites>hydrophilic viruses>lipophilic viruses>vegetative fungi and fungal spores>vegetative bacteria
   Most parasites, such as Acanthamoeba castellanii, Giardia and Cryptosporidium spp., are significantly resistant to disinfection and are usually rated between mycobacteria and viruses. Adequate hospital rooms, labs, surgical suits, and laundry disinfection should reduce infectivity to patients, nurses, doctors, and other workers, with greatest attention to disinfection of highly resistant infectious microbes such as C. diff antibiotic resistant microbes. Currently, Chlorhexidine Organic Salts comprise most medical disinfection applications (polyaminopropyl biguanide (PAPB)). It is a single disinfectant, which does not inactivate many of these resistant infectious agents. Stabilized chlorine dioxide and quaternary ammonium compounds kills molds, bacteria, and viruses with dual stressors, we have not observed that it is effective against spores and parasites.

In another embodiment, a new chemical formulation according to the present invention comprises stabilized chlorine dioxide, quaternary ammonium compounds and ammonia. The use of ammonia enables the disinfectant to kill all the microbial groups (bacteria, molds, viruses, parasites, and bacterial spores). At the cellular level, this combination of disinfectants constitutes multi-stressing microbial structures to inactivate these different microbial groups.

The capsulated of the formation and effectiveness of inactivating infectious agents is elucidated in table 8.

TABLE 8
Summary of the disinfection solution according to the present invention

| | | Degree of | |
|---|---|---|---|
| Ingredient | Concentrations | Inactivation | Comments |
| Chlorine | Stabilized ClO₂ 0.2% 2.000 | 9 log reduction of | Inactivates |
| Dioxide | mg/L | bacteria and | bacteria and |
| | ClO₂ 100-200 mg/L | 6 log reduction. of | Inactivates Non- |
| | NaClO₂ 1900-1800 mg/L | virus in municipal | enveloped and |
| | | sludge | Enveloped viruses |
| | | | as noted in the |
| | | | literature on vital |
| | | | oxide and the |
| | | | Neutralizer process. |
| Quats | C12-C14 alkyl(ethylbenzyl) | 9 log reduction of | Inactivates |
| | dimethylammonium chloride | bacteria | bacteria and |
| | 0.5% (5.0 g/L) | 6 log reduction. of | Inactivates Non- |
| | to 1% (10 mg/L) | virus | enveloped and |
| | | | Enveloped viruses |
| | | | as noted in the |
| | | | literature on vital |
| | | | oxide. |
| Ammonium | 20,000 mg/L of NH₄H₂PO₄ | 6 log reduction of | This data comes |
| Phosphate | At pH of 7.4 NH₃⁺ = 30 mg/L | parasites and | from biosolids |
| | At pH of 8.4 NH₃⁺ = 300 mg/L | protozoan oocysts | disinfection and |
| | Non-charged disinfectant | | contact lens |
| | | | treatment/and |
| | | | disinfect wounds. |
| Buffers | Phosphate Buffer at a pH | The buffer controls | The buffers will |
| | of 7.4 or | the NH₃ | also control the |
| | Na₂HPO₄ = 12.7 g/L | concentrations | stability of the |
| | NaH₂PO₄= 3.2 g/L | | water which |
| | Carbonate Buffer at a pH of 8.4 | | controls corrosion |
| | NaCO₃ = 9.0 g/L | | |
| Ionic | NaCl = 6.5 g/L and | Gives the blend | It assists in controlling |
| Strength | KCl = 2.5 g/L | conductivity to | water stability |
| | | control corrosion | |
| Surfactant | Tetronic 908 = 2.5 g/L | | It is a surfactant |
| | | | enabling the |
| | | | formation to get |
| | | | proper mixing. |

In an embodiment, the present invention is not cytotoxic at chlorine dioxide concentration of less than 2%. At 10 times in concentration in comparison to Ascepticys, the present invention has great potential in swift and efficient environmental disinfection. The physical properties and the chemical properties of the solution are elucidated in the following section.

TABLE 9
Physical properties of solution according to the present invention

| | Liquid solution | | |
|---|---|---|---|
| 1 Physical state | | | |
| Appearance | Pale yellow | Odor | Similar to chlorine |
| Color | White | Odor threshold | Not determined |
| 2 Physical state | | | |
| Appearance | Was like | Odor | Characteristic |
| Color | Colourless, beige | Odor threshold | ND |

TABLE 10
Physical Properties of the solution

| | | | | Remarks- |
|---|---|---|---|---|
| Property | Values1 | 2 | 3 | Method |

| | | |
|---|---|---|
| Appearance | ND | Wax like |
| Physical State | ND | Wax like |
| Odor | ND | ND |
| Odor Threshold | ND | ND |
| pH | 10 | ND |
| | approximately | |
| | 100 g/L water | |
| Melting/Freezing | ND | ND |
| Point | | |
| Boiling point/range | ND | ND |
| Flash point | ND | ND |
| Evaporation rate | ND | ND |
| Flammability | ND | ND |
| (solid, gas) | | |
| Upper flammability | ND | ND |
| limits | | |
| Lower flammability | ND | ND |
| limits | | |
| Vapor pressure | ND | ND |
| Vapor density | ND | ND |
| Specific gravity | 1.15 g/Liter | ND |
| | Max: 0.4 gm/L | |
| | (4 ppm) | |
| Water solubility | Unlimited | ND |
| Solubility in other | ND | ND |
| solvents | | |
| Partition coefficient | ND | ND |
| Auto-ignition | ND | ND |
| temperature | | |
| Decomposition | ND | ND |
| temperature | | |
| Kinematic viscosity | ND | ND |
| Dynamic viscosity | ND | ND |
| Explosive | ND | ND |
| properties | | |
| Oxidizing | ND | ND |
| properties | | |

TABLE 11
Product Chemistry Data Requirements

| | |
|---|---|
| Chemical | Conc. (%, w/w) |

Active ingredients

| | |
|---|---|
| SCD | 0.20 |
| Quaternary Ammonia | 0.50 |
| (C12-C14) | |
| Ammonium Phosphate | 2.0 |

Buffering agent

| | |
|---|---|
| Sodium carbonate | 0.1 |

TABLE 12
Product Chemistry Data - Stabilized Chlorine Dioxide

| | |
|---|---|
| Guideline | |
| Number | Data Requirement |

Product Identity and Composition

| | | |
|---|---|---|
| 830.1550 | Product identity and composition | Stabilized chlorine dioxide [ClO2] |
| | | CAS#: 10049044 |
| 830.1600 | Description of materials used to | Sodium chlorate |
| | produce the product | |
| 830.1620 | Description of production process | Reduction of sodium chlorate |
| 830.1650 | Description of formulation process | chlorate + acid + reducing agent → |
| | | chlorine dioxide + by-products |
| 830.1670 | Discussion of formulation of | NA |
| | impurities | |
| 830.1750 | Certified limits | 0.1% |
| 830.1800 | Enforcement analytical method | EPA Method 327.0: Determination of |
| | | ClO2 and Chlorite Ion in Drinking Water |
| | | Using Lissamine Green B and |
| | | Horseradish Peroxidase (HRP) with |
| | | Detection by Visible Spectrophotometry |

Physical and Chemical Properties

| | | |
|---|---|---|
| 830.6302 | Color | Yellow or reddish |
| 830.6303 | Physical state | gas |
| 830.6304 | Odor | Acrid |
| 830.6313 | Stability to normal and elevated | May cause fire or explosion, strong |
| | temperatures, metals, and metal ions | oxidizer, keep away from heat. |
| 830.6317 | Storage stability | Keep container tightly closed in a dry and |
| | | well-ventilated place. |
| | | Never allow product to get in contact with |
| | | water during storage. Do not store near acids. |
| | | Keep in a dry place. |
| | | Storage class (TRGS 510): 5.1A: |
| | | Strongly oxidizing hazardous materials |
| 830.6320 | Corrosion characteristics | |
| 830.7200 | Melting point/melting range | −59° C. (−74° F.; 214 K) |
| 830.7220 | Boiling point/boiling range | 11 C. (52° F.; 284 K) |
| 830.7300 | Density/relative density/bulk density | 2.757 g dm⁻³ |
| 830.7370 | Dissociation constants in water | NA |
| 830.7550 | Partition coefficient (n-octanol/water) | Log Kow = −3.22 |
| 830.7560 | | |
| 830.7570 | | |
| 830.7840 | Water solubility | 1000000 |
| 830.7860 | | |
| 830.7950 | Vapor pressure | >1 atm, 25° C. |

When chlorine dioxide dissolves in water, it rapidly reacts to form chlorate, chlorite, and chloride ions. The IRIS oral toxicity data for chlorine dioxide is largely based on the toxicity of sodium chlorite. The water decay term for chlorine dioxide used in the RSEI model reflects rapid hydrolysis to sodium chlorite, which is toxic and does not decay rapidly in water.

TABLE 13
Product Chemistry Data - Quaternary Ammonium

| | |
|---|---|
| Guideline | |
| Number | Data Requirement |

Product Identity and Composition

| | | |
|---|---|---|
| 830.1550 | Product identity and composition | Quaternary Ammonium (C12-C14) N- |
| | | alkyl ethylbenzyl dimethyl ammonium |
| | | (C12-C14) |
| | | NR⁺₄ |
| 830.1600 | Description of materials used to | tertiary amines and halocarbon |
| | produce the product | |
| 830.1620 | Description of production process | alkylation of tertiary amines with a halocarbon |
| 830.1650 | Description of formulation process | CH3(CH2)nN(CH3)2 + ClCH2C6H5 → |
| | | [CH3(CH2)nN(CH3)2CH2C6H5] + Cl— |
| 830.1670 | Discussion of formulation of | |
| | impurities | |
| 830.1750 | Certified limits | 0.1% |
| 830.1800 | Enforcement analytical method | conventional chromatography techniques |

Physical and Chemical Properties

| | | |
|---|---|---|
| 830.6302 | Color | White or yellow |
| 830.6303 | Physical state | powder, gelatinous lumps |
| 830.6304 | Odor | |
| 830.6313 | Stability to normal and elevated | |
| | temperatures, metals, and metal ions | |
| 830.6317 | Storage stability | |
| 830.6320 | Corrosion characteristics | |
| 830.7050 | UV/visible light absorption | |
| 830.7200 | Melting point/melting range | |
| 830.7220 | Boiling point/boiling range | |
| 830.7300 | Density/relative density/bulk density | 0.98 g/cm³ |
| 830.7370 | Dissociation constants in water | |
| 830.7550 | Partition coefficient (n-octanol/water) | |
| 830.7560 | | |
| 830.7570 | | |
| 830.7840 | Water solubility | Very soluble |
| 830.7860 | | |
| 830.7950 | Vapor pressure | |

TABLE 14
Product Chemistry Data - Ammonium Phosphate Dibasic

| | |
|---|---|
| Guideline | |
| Number | Data Requirement |

Product Identity and Composition

| | | |
|---|---|---|
| 830.1550 | Product identity and composition | Ammonium Phosphate Dibasic |
| | | [(NH₄)₂HPO₄] |
| 830.1600 | Description of materials used to produce | ammonia (NH3) with Phosphoric acid |
| | the product | |
| 830.1620 | Description of production process | Double-decomposition |
| 830.1650 | Description of formulation process | NH3 + H₃PO₄ |
| 830.1670 | Discussion of formulation of impurities | NH₄ |
| 830.1750 | Certified limits | 2% |
| 830.1800 | Enforcement analytical method | |

Physical and Chemical Properties

| | | |
|---|---|---|
| 830.6302 | Color | White solid |
| 830.6303 | Physical state | Hygroscopic |
| 830.6304 | Odor | Odorless |
| 830.6313 | Stability to normal and elevated | Decomposes at 155° C. at 1 atm |
| | temperatures, metals, and metal ions | |
| 830.6317 | Storage stability | Stable under recommended storage |
| | | conditions, concentrated solution of |
| | | ammonium chloride may crystallize |
| | | when exposed to low temperature, |
| | | may volatize and condense on cool |
| | | surfaces. |
| 830.6320 | Corrosion characteristics | At fire temp corrodes metals |
| 830.7050 | UV/visible light absorption | NA |
| 830.7200 | Melting point/melting range | 155° C./311° F. |
| 830.7220 | Boiling point/boiling range | Decomposes at 155° C. |
| 830.7300 | Density/relative density/bulk density | 1.619 g/cu cm |
| 830.7370 | Dissociation constants in water | NA |
| 830.7550 | Partition coefficient (n-octanol/water) | NA |
| 830.7560 | | |
| 830.7570 | | |
| 830.7840 | Water solubility | 69.5 g 100 g (25° C.) |
| 830.7860 | | |
| 830.7950 | Vapor pressure | |

In 2010, EPA concluded that “[n]”either ammonia nor urea, by itself, has pesticidal (a term that includes antimicrobial) activity”. Instead, ammonium salts are listed by EPA as an “other ingredient” (including ammonium phosphate).

EPA has carefully reviewed the available information concerning how ammonia and urea function as part of biocidal control systems in the pulp and paperboard industry, as well as how Ashland, Buckman, and Nalco intend their ammonia and urea products to be used. Neither ammonia nor urea, by itself, has pesticidal activity. Nonetheless, the ways in which the three companies market their ammonia and urea products, as well as the known and intended uses of those products in the pulp and paperboard industry, bring those products within the definition of a pesticide. Specifically, EPA has determined that the three companies directly state or imply and intend that their products should be added to chlorinated water as part of a biocide control system in the pulp and paperboard industry where the material will interact with chlorine that is also added to the water. In an embodiment, once the ammonia or urea is added, it reacts with chlorine to ultimately form a new chemical substance, chloramine. (Urea in the presence of sodium hypochlorite or a chlorine source forms a chlorourea, which undergoes further chemical reaction to form chloramine.) As the three companies know, the chloramine formed following the addition of ammonia and urea to chlorinated water has pesticidal activity against microbial organisms. Moreover, compared to chlorine, chloramine exhibits extended antimicrobial activity.

In an embodiment what distinguishes the current composition from the prior art is not simply the change in sources of nonionized ammonia, but the concentrations of the constituents, the speed of their action, and their disinfection targets.

The prior art composition targets materials that will come into contact with human tissue, and human tissue itself. Further, it acts to kill organisms over a much longer period of time—no less than 30 minutes and more often 60 to 90 minutes (ex: U.S. Pat. No. 10,261,971). It was developed for use on contact lenses and surgical equipment.

In contrast, in an embodiment. the composition of the present disclosure is much stronger and at its weakest, is stronger than the strongest concentration of the prior art. This is because the disclosure of the present invention must kill organisms in less than 10 minutes, as required by EPA.

The prior art never tested against either C. diff or C. perfringens. In contrast, as the present disclosure explain, the nonionized ammonia in the present composition will kill C. perfringens spores in wastewater sludge, a medium far more difficult to disinfect than the 5% blood plasma solution used in the EPA required test.

U.S. Ser. No. 10/251,971B2, US20180221407A1, U.S. Pat. Nos. 10,478,407B2, 8,998,518B2, 4,073,888A, 9,340,756 B2, US20110056524A1 are incorporated herein by reference in their entirety.

### EXPERIMENTAL SECTION

### Example 1: Association of Official Agricultural Chemists Germicidal Efficacy

The purpose of this test is to determine the effectiveness of a product as a disinfectant for hard surfaces. This method is in compliance with the requirements of and may be submitted to, one or more of the following agencies as indicated by the Sponsor: U.S. Environmental Protection Agency (EPA) and Health Canada.

Regulatory agencies require that a specific organism claim for a test substance intended for use on hard surfaces be supported by appropriate scientific data demonstrating the efficacy of the test substance against the claimed organism. This is accomplished by treating the target organism with the test substance under conditions which simulate as closely as possible, in the laboratory, the actual conditions under which the test substance is designed to be used. For products intended for use on hard surfaces (dry, inanimate environmental surfaces), a carrier method is used in the generation of the supporting data. The experimental design in this protocol meets these requirements.

A film of organism cells dried on a surface of glass slide carriers is exposed to the test substance for a specified exposure time. After exposure, the carriers are transferred to vessels containing neutralizing subculture media and assayed for survivors. Appropriate culture purity, sterility, viability, neutralization confirmation and carrier population controls are performed. The test organism(s) used in this study was obtained from the American Type Culture Collection (ATCC), Manassas, Va. An embodiment of the disinfectant solution described herein, at the lowest level of concentrations shown in Table 15 was tested.

TABLE 15
Results of AOAC Spray Efficacy Testing

| | | Incubation | |
|---|---|---|---|
| Test Organism | Growth Medium | Parameters | Result |
| Staphylococcus | Synthetic Broth | 35-37° C., aerobic | Successful |
| aureus | | | 1 of 60 positive |
| Pseudomonas | Nutrient Broth | 35-37° C., aerobic | Successful |
| aeruginosa | | | 0-60 positive |

### Example 2: OECD Efficacy Test on Spores of Clostridium Difficile

Spore forming bacteria produce a unique resting cell called an endospore. They are Gram-positive and usually rod-shaped, but there are exceptions. Bacterial spores are made of a tough outer layer of keratin that is resistant to chemicals, staining and heat. The spore allows bacterium to remain dormant for years, protecting it from various traumas, including temperature differences, absence of air, water and nutrients.

The two medically important genera are Bacillus, the members of which are aerobic spore formers in the soils, and Clostridium, whose species are anaerobic spore formers of soils, sediments and the intestinal tracts of animals. Some spore formers are pathogens of animals and humans, usually due to the production of powerful toxins. Bacillus anthracis causes anthrax, a disease of domestic animals, which may be transmitted to humans. Clostridium perfringens causes gangrene, and Clostridium difficile causes a severe form of colitis called pseudo-membranous colitis and is a major cause of nosocomial infection and death in health care facilities.

Since the 1980's, Clostridium spores have been used as a surrogate organism for the inactivation of helminths eggs to ascertain biosolids disinfection. This was done due to the low density of helminth eggs in municipal sludge. Clostridium perfringens is found in municipal sludge at densities of 104 to 106 per gram dry weight. The surrogate indicators of interest are naturally and ubiquitously present in the biosolids matrix. Assays for these organisms take days instead of weeks to complete. These organisms fulfill the characteristics for a good microbial surrogate indicator (Blanker, et. al, 1992 and Pratt et. al., 2004).

These spores are resistant to heat, alkaline pH, acidic pH and strong oxidants (ozone, chlorine dioxide and peracetic acid). The above factors explain why C. diff is a major infectious agent in hospital situations. C. diff bacteria actually exists in all environments and is found in the intestines of humans with no symptoms. Older adults in health care facilities and hospitals are most at risk, especially if they are taking antibiotics. That is because the human body contains enough healthy bacteria to prevent excessive C. diff growth, but when the antibiotics kills these bacteria, then the C. diff can grow unchecked and cause severe illness and death. C. diff in medical wastes thus imposes a significant risk to medical facility staff and especially to waste disposal personnel who would normally be entirely unaware of the potential exposures, both to what is in the red bags and what is likely to be on the outside of the red bags.

To address disinfection-resistant endospores, embodiments of the disinfectant solution described herein contain the non-charged disinfectant ammonia. Data from inventors' work with these surrogates illustrates that these formulations will inactivate spore forming bacteria and parasites. This data document ammonia is effective in inactivation of spore forming bacteria and parasites with five log reductions where raw biosolids concentrations of C. perfringes at a level of 1×10⁷ was reduced by the Ammonia at 0.1% w/w to a level of less than 2×10².

The disinfection efficacy of ammonia rises from use of an un-ionized molecule (NH3) rather than by the ionized fraction (NH4+), the two of which coexist in equilibrium in ammonia—in—water systems (Thurston et al., 1989).

It should be noted that this information is related to municipal sludge, which by EPA definition, has a consistency of eggnog due to the suspended solids. This factor, combined with the complex nature of chemical reactions, hydrolysis and thermodynamics, makes sludge highly difficult to treat in regard to disinfection and sanitation. Helminth eggs are selected as an indicator for disinfection since they are more resistant to heat, alkaline/acid conditions, pressure, and other stressors, than other organisms commonly presented in municipal sludge.

The data referenced above indicates that ammonia is efficient in disinfecting municipal sludge. Considering that ammonia (0.1-1%) was able to reduce Clostridium perfringens spores in sludge, and the C. diff and C. perfringens are both non-charged spores with similar physiologies, the embodiments of the disinfectant solution disclosed herein will demonstrate very high disinfecting efficiencies against C. diff when applied as a spray, fog or wipe, in a much-simplified condition compared to wastewater sludge.

The embodiment of the disinfectant solution disclosed herein has been tested for efficacy against C. diff. The purpose of that study was to evaluate kill and/or inactivation against C. difficile spores on hard, non-porous surfaces. The method used is in compliance with the requirements of and may be submitted to, one or more of the following agencies as indicated by the Sponsor: U.S. Environmental Protection Agency (EPA) and Health Canada.

This method was used to quantify the ability of the embodiment of the disinfectant solution described herein to inactivate bacterial spores on environmental surfaces, where the concentration of the disinfectant was at the lowest levels shown in Table 21.

For test substances intended for use on hard surfaces (dry, inanimate environmental surfaces) a carrier method is used in the generation of data. This is accomplished by drying an aliquot of the selected organism on to the surface of a disk carrier and then treating the dried film with test substance under conditions which simulate as closely as possible, in the laboratory, the actual conditions under which the disinfectant is designed to be used. The test system follows US EPA MLB SOP MB-28 and US EPA MLB SOP MB-31. This method may also be used to support claims for towelette-based products utilizing the liquid expressed from the wipes. This method may also be used to evaluate spray products by directly aliquoting the spray product onto the carriers. The U.S. EPA and Health Canada require products demonstrate efficacy as a hospital disinfectant before claims against C. difficile spores can be made.

A film of bacterial spores dried on a surface of stainless-steel disk carriers is exposed to the test substance for a specified exposure time. After exposure, the carriers are neutralized and assayed for survivors. Appropriate neutralization confirmation, sterility, spore titer, spore qualification, and carrier population/culture purity controls are performed. The Standard Operating Procedure CGT-0121 reflects the methods which shall be used in this study. The test organism used in this study was obtained from the American Type Culture Collection (ATCC), Manassas, Va. An embodiment of the disinfectant solution disclosed herein was tested at the lowest level of concentrations shown in Table 16.

TABLE 16
Results of OECD Efficacy Test on Clostridium Difficile

| Test Organism | Growth Medium | Result |
|---|---|---|
| Clostridium difficile - | CDC Anaerobic Blood | Successful |
| spore form | Agar | ≥6 Log reduction |

### Example 3: ISO Efficacy Test

Standard methods for assessing the antimicrobial activity of multipurpose disinfection solutions have also been harmonized under International Standards Organization (ISO) standard laboratory procedures using a battery of preselected bacterial and fungal species. One embodiment of the formulation disclosed herein was found to be broadly effective against multiple microbial pathogens by inclusion of multiple chemical stressors. Using ISO testing protocol 14729 (antimicrobial), the ISO-required battery of microorganisms (S. aureus, P. aeruginosa, S. marcesens, C. albicans, and F. solani) was used to assess the disinfection potential of one embodiment of the essential disinfecting solution disclosed herein, with contact times of one hour and four hours and applying a disinfection process consisting of a disinfectant bath. The disinfection potential of one embodiment of the essential disinfection solution disclosed herein under the ISO-specific antimicrobial assay demonstrated no bacterial or fungal plate growth for any of the microorganisms tested. Under the ISO testing protocol 14729, one embodiment of the essential disinfection solution disclosed herein produced the following log reductions for the following organisms: S. aureus (>6 logs), P. aeruginosa (>5 logs), S. marcesens (>8 logs), C. albicans (>6 logs), and F. solani (>5 logs). These results establish that using a bath process, one embodiment of the disinfection process disclosed herein is an effective disinfection process across a broad spectrum of microorganisms.

### Example 4: Exemplary Phosphate Buffer Based Formulation

One embodiment of the essential disinfection solution disclosed herein tested for antimicrobial activity using standard procedural methodology (International Standards Organization) and at the minimum inhibitory concentrations (MIC), defined as the lowest concentration of antimicrobial that will inhibit the visible growth of a micro-organism after incubations. In this particular set of MIC assays, either one or more of the active components of the embodiment of the essential disinfection solution disclosed herein, were added (100 μl) to an innoculum (10 ml) of a Gm+(Staphylococcus aureus), Gm− (Pseudomonas aeruginosa), or fungi (Candida albicans, Fusarium albicans) each at an approximate concentration of 1.0E+04-1.0E+06 CFU/ml. After a 24-hour contact time, a sample of each test tube was 65 plated on media specific to each bacterium or fungi, and growth was recorded. Growth of more than one colony on any of the agar plates was considered a failure (positive) of one or more of the components of the novel formulation to kill the microbial innoculum at that selected concentration of the component and/or mixture thereof. MIC testing usually was initiated with higher concentrations of the components and then halted once, by virtue of dilution, the MIC is achieved for each component and/or mixtures thereof. The results of these tests are shown in Table 17.

TABLE 17
MIC Biocidal Test Results

| Ingredient | % w/w |
|---|---|
| Stabilized Chlorine Dioxide | 0.005% to 1.0% |
| C12-C14 alkyl (ethylbenzyl) dimethyl | 0.00005% to 0.1% |
| ammonium chloride | |
| Ammonia (NH₃) | 0.0001% to 0.2% |

Biocidal Test Results

| | |
|---|---|
| P. aeruginosa | No growth |
| S. aureus | No growth |
| C. albicans | No growth |
| F. solani | No growth |

### Example 5: Essential Disinfectant Solution is Effective Against Protozoa Acanthamoeba SPP

Free living amebae of the genus Acanthamoeba are saprophytic protozoa that are ubiquitous in the environment. Particular species of the genus, including Acanthamoeba castellanii, can cause severe infections in man. One manifestation of A. castellanii infection includes extremely rare opportunistic granulomas encephalitis that can develop only after accidental oral/nasal insufflation. A more common, albeit rare, disease syndrome includes Acanthamoeba keratitis resulting from inadvertent ocular exposure to environmental sources. The latter condition is considered a severe form of keratitis that can lead to long term sequelae including blindness if left untreated. A significant increase of diagnosed cases of Acanthamoeba keratitis has been observed over the last decade.

There are few options for treatment of Acanthamoeba keratitis. Conventional chemotherapeutic agents, including antibiotics and antifungals have no efficacy against this agent. Biocidal agents, including povidone-iodine, polyhexamethylene biguanide (Baquacil), hexamidine, and chlorhexidine, collectively have shown marginal efficacy but are also cytotoxic to human tissue.

The anti-protozoal efficacy of an embodiment of the essential disinfection solution disclosed herein, (comprising stabilized chlorine dioxide, ammonia and C12-14-alkyl (ethylbenzyl) dimethyl ammonium chloride) against A. castellanii trophozoites in an experimental colorimetric assay (McBride, J, 25 Ingram, P R, Henriquez, F L, Roberts, C W. J Clin Microb, February; 43(2):629-34, 2005) was tested. Trophozoites were enumerated using a Coulter cell counter and verified by light microscopy and a hemocytometer. Alamar blue was used as a vitality dye, and effectively measures cellular respiration. The intensity of the dye degraded at an equivalent rate of remaining active trophozoites in solution; thus the reciprocal of the measured absorbance of the dye was correlative to the remaining active trophozoites in the test well. Predetermined concentrations of active trophozoites (1.2E+3 cells/well) were used for the assay, and exactly 25 μl of the disinfection solution or dilutions

Thereof were aliquoted into A. castellanii-loaded wells; testing was performed in sextuplicate (6 wells/solution). Disinfectant-A. castellanii solutions were then incubated for either 96 or 1 hour and then read on a spectrophometer at 570 nm.

The embodiment of the essential disinfection solution was efficacious in killing all trophozoites at both incubation times and maintained effectiveness even when serially diluted (1:10).

### Example 6: Inactivation of Fecal Coliform, Poliovirus and Aerobic Endospores in Sludge

The efficacy of an embodiment of the essential disinfection solution disclosed herein, when used to disinfect sludge, extends to beyond spores. Exposing sludge to an embodiment of the solution disclosed herein at 0.1% w/w ammonia, resulted in the following log reductions: Fecal Coliform (6.18 logs), Poliovirus (7.11 logs), Aerobic Endospores (6.59 logs).

### Example 7: Sewage Backup

The embodiments of the essential disinfection solution disclosed herein have been used in environmental settings. In December 2018, a firm was called in by a local Hospital to remediate sewage backup in their old cafeteria dishwashing area. To sterilize this highly contaminated kitchen, they applied ammonia and a mixture of quaternary amines and stabilized chlorine dioxide. The levels of mold and sewage sludge bacteria were highly contaminated as expected with a sewage back up. After treatment with ammonia and the C102/quat mixture, which was an embodiment of the presently disclosed formulation, the bacterial contamination was reduced below detection limits and air mold levels were below outside mold criteria.

TABLE 18
Observed Levels of Sewage Bacteria before and after Treatment (CFU/g)

| | | | | | Fecal |
|---|---|---|---|---|---|
| Sample | Total Coliform | Fecal Coliform | E. coli | Enterococci | Streptococcus |
| Before | 6.3 × 10⁶ | 3.5 × 10³ | 3.5 × 10³ | 0.6 × 10³ | 1.1 × 10³ |
| After | <1.0 × 10⁶ | <1.0 × 10² | <1.0 × 10² | <1.0 × 10² | <1.0 × 10² |
| Detention | <1.0 × 10⁶ | <1.0 × 10² | <1.0 × 10² | <1.0 × 10² | <1.0 × 10² |
| Limit | | | | | |
| Comments | Inactivate to | Inactivated to | Inactivated to | Inactivated to | Inactivated to |
| | about one log | about 1.5 logs | about 1.5 logs | about 1.1 logs | about 1.1 logs |
| | reduction | | | | |

The bacterial levels were below 10³ which is below the level noted for disinfected municipal biosolids.

### Example 8: Safety in Environmental Settings

The embodiments of the essential disinfection solution disclosed herein have been developed to ensure it presents no corrosion or stability problems. Various embodiments of the essential disinfection solution disclosed herein blend the designated chemicals into a homogenized solution (Table 24 presents an embodiment with a bicarbonate buffer and Table 25 presents and embodiment with a phosphate buffer). These, and other embodiments, use additional ingredients to achieve water stability where the final solution will neither be corrosive nor will it precipitate during storage.

TABLE 19
Disclosed Disinfection Formulation with
Bicarbonate Buffer pH = 8.4 (100 gallons)

| | |
|---|---|
| Ingredients | Concentration |

Active Ingredients

| | |
|---|---|
| Stabilized Chlorine Dioxide | 0.2% or 2 g/L |
| C12-C14 alkyl (ethylbenzyl) dimethyl | 0.5% or 5 g/L |
| ammonium chloride | |
| Ammonium Phosphate Dibasic | 2.0% or 20 g/L |

Buffering Ingredients

| | |
|---|---|
| Sodium Bicarbonate | 0.2% or 2 g/L |
| Tetronic (Surfactant) | 0.25% or 2.5 g/L |
| Sodium Chloride | 0.65% or 6.5 g/L |
| Potassium Chloride | 0.25% or 2.5 g/L |

TABLE 20
Present Disinfection Formulation with
Phosphate Buffer pH = 8.0(100 gallons)

| | |
|---|---|
| Ingredients | Concentration |

Active Ingredients

| | |
|---|---|
| Stabilized Chlorine Dioxide | 0.2% or 2 g/L |
| C12-C14 alkyl (ethylbenzyl) dimethyl | 0.5% or 5 g/L |
| ammonium chloride | |
| Ammonium Phosphate Dibasic | 2.0% or 20 g/L |

Buffers

| | |
|---|---|
| Sodium Dihydrogen Phosphate | 0.05% or 0.5 g/L |
| Sodium Nonhydrogen Phosphate | 1.67% or 16.7 g/L |

Inert Ingredients

| | |
|---|---|
| Tetronic (Surfactant) | 0.25% or 2.5 g/L |
| Sodium Chloride | 0.65% or 6.5 g/L |
| Potassium Chloride | 025% or 2.5 g/L |

### REFERENCES CITED

All references, including granted patents and patent application publications, referred herein are incorporated herein by reference in their entirety.

### U.S. PATENT DOCUMENTS

| Document No. | Date | Inventor |
|---|---|---|
| 10,251,971 B2 | Apr. 9, 2019 | Roy, C., et al. |
| 63193364 | May 26, 2021 | Reimers, R, et al. |

### OTHER PUBLICATIONS

ASTe, LLC Report, 2020. “Remediation of Hospital Contamination for Sewage Backup,” Submitted to hospital regulatory authority.
Blanker, E. M., M. D. Little, R. S. Reimers, and T. G. Akers. (1992) “Evaluating the use of Clostridium perfringens spores as indicator of the presence of viable Ascaris eggs in chemically treated municipal sludges.” The Future Direction of Municipal Sludge Biosolids Management: Where we are and Where We're Going, Proceedings, Specialty Conference, Portland, Oreg., Jul. 26-30, 1992, Vol. 1. Portland, Oreg.: Water Environment Federation
Brulle, R. J. and Pellow, D. N., “ENVIRONMENTALJUSTICE: Human Health and Environmental Inequalities”, Annual Review of Public Health 2006 27:1, 103-124 accessed May 19, 2021 https://www/annualreviews.org/doi/abs/10.1146/annurev.publhealth.27.021405.102124.
Castanie, T. and Wilson, D. E. 2018. “Limited Sewage Sludge and Mold Swab Testing MHNE Old Cafeteria Dishwashing Area,” ASTE, LLC Report, Centers for Disease Control and Prevention, “Biggest Threats and Data— 2019 A R Threats Report” (Mar. 2, 2021) https://www/cdc.gov/drugresitance/biggest-threats.html#cdiff (accessed May 21, 2021).
Centers for Disease Control and Prevention, “Antibiotic Resistance Threats in the United States 2019, https://www.cdc.gov/drugresistance/pdf/threats-report/2019-ar-threats-report-508.pdf (accessed Nov. 5, 2021).
Centers for Disease Control and Prevention, “Biggest Threats and Data—2019 A R Threats Report” (Mar. 2, 2021) https://www.cdc.gov/drugresistance/biggest-threats.html#cdiff (accessed May 21, 2021).
Centers for Disease Control and Prevention, “Healthcare-associated infections” (February 2015) https://www.cdc.gov/hai/dpks/deadly-diarrhea/dpk-deadly-diarrhea.html#:˜:text=difficile%20infections%20cause%20immense%20suffering.death%2 0in% 20the%20United%20States (accessed May 19, 2021).
Centers for Disease Control and Prevention, The Direct Medical Costs of Healthcare Associated Infections in U.S. Hospitals and the Benefits of Prevention, March 2009, https://www.cdc.gov/hai/pdfs/hai/scott_costpaper.pdf (accessed Nov. 5, 2021).
Fears, A. C., Metzinger, R. C., Killeen, S. Z., Reimers, R. S., and Roy, C. R., 2018. Comparative In Vitro Effectiveness of a Novel Contact Lens Multipurpose Solution on Acanthamoeba castellanies. Journal of Ophthalmic Inflammation and Infection:il.ios
Fitzmorris, K. B. and Reimers, R. S., “Developments in Disinfection Using Advanced Alkaline Stabilization,” WEF Specialty Conference Disinfection and Public Health, Water and Environmental Federation, Alexandria, Va. (February, 2013)
Fitzmorris, K. B. and Reimers, R. S., 2011. Report on Bioset Process to Achieve Class A Disinfection, Report to USEPA PEC Committee.
Fitzmorris. K. B., and Reimers, R. S., 2009. Physical, Chemical and Biological Agents Impacting Disinfection in Residuals, WER Residuals and Biosolids 2009 Specialty Conference, Atlanta, Ga. CD-ROM.
Fitzmorris-Brisolara, K. B. and Reimers, R. S., 2011. “Pathogen Inactivation in an Advanced Alkaline System,” WEF Disinfection 2011 Specialty Conference, Cincinnati, Ohio. CD-ROM.
Hoffmann, J. P., Friedman, J. K., Wang, Y., McLachian, J. B., Sammarco, M. C., Morici, L. A. and Roy, C. J., 2020. “In situ Treatment with Novel Microbicide Inhibits Methicillin Resistant Staphylococcus aureus in a Murine Wound Infection Model,” Frontiers in Microbiology, Volume 10, Article 3106.
IUVO Bioscience, 2018. “Report on the Stability and Disinfection of Asepticys for USDA” the report submitted to Asepticys LLC.
Karas J A, Enoch D A, Aliyu S H. A review of mortality due to Clostridium difficile infection. J Infect 2010; 61:1-8
Meehan, P. P., Reimers, R. S., Akers, T. G., Little, M. D., Metcalf, M. C., and Lo, C. P. (1986) “Development of Chemical Fixation Process to PFRP Classification for Municipal Sludge Treatment—Enabling the Reuse of the Resulting Product.” EPA Program Solicitation DU-85-BO46, Small Business Innovative Research.
Price, D. L. and Eason, B. M., 2009. “Comparison of Vital Oxide and Beneffect Disinfectants,” Microbiology Laboratory Report to Vitol Solutions, Inc., InterfaceFLOR Research and Development, LaGrange, Ga.
Reichold, K., Heagle, R., Newton, C. and Asman, C., 2017. “Update: Karcher Mister with Vital Oxide shows Dramatic Results with a Supplemental Program at St. Mary's Hospital”, Vital Solutions and Karcher North America, Inc. Report to St. Mary's Medical Center, WestPalm Beach, Fla.
Reimers, R. S. and Little, M. D. “Sludge Treatment Process,” Synox Process Development, U.S. Pat. No. 5,281,341 (Jan. 25, 1994).
Reimers, R. S., Little, M. D., Akers, T. G. and Meehan, P. P. “A Chemical Process to Inactivate Pathogens in Municipal Wastewater Treatment Sludge,” Assigned to Tulane University and Licensed by Chemfix Technologies, Inc., U.S. Pat. No. 4,853,208, Metairie, La. (December 1988).
Reimers, R. S., Mussari, F. P., and Schmitz, W., Oct. 9, 2007 “Sludge Treatment Process”, The Administrators of the Tulane Educational Fund and FKOS, LLC U.S. Pat. No. 7,279,099.
Reimers, R. S., Oleszkiewicz, J. A., Sheppard, S. L., Bakeer, R. M. and Little, M. D., 2001. Advances in Alkaline Stabilization/Disinfection Agricultural and Municipal Biosolids, IWA Proceedings on Sludge Management Entering the Third Millennium, IWA, Taipei, Taiwan pp. 104-110.
Reimers, R. S., Pillai, S. D., Bowman, D. D., Fitzmorris, K. B. and Pratt, L. S. 2005. “Stressors Influencing Disinfection in Residuals”. Disinfection 2005—Sharing Disinfection Technologies: Water, Wastewater, and Biosolids. Water Environment Federation, Alexandria, Va., CD-ROM.
Reimers, R. S., Pratt-Ward, L. S., Bradford, H. B., Mussari, F. P. and Schmitz, W. 2006. Development of the Neutralizer Process for Disinfection and Stabilization of Municipal Wastewater Residuals, WER Residuals and Biosolids Specialty Conference, Cincinnati, Ohio, WER Alexandria, Va. CD-ROM
Reimers, R. S., Xu, Y., Wilson, D. E., Gregory, C. C. and Agnew, A. M., 2020, “Pathogenic Assessment of Pinnacle Chlorine Dioxide Blends for Disinfection for Healthcare Facilities and Hospitals,” A Pinnacle Environmental Solutions Report, Simonton, Tex.
Roy, Chad, Metzinger, Rebecca and Reimers, R., “Compositions and Methods for Multipurpose Disinfection and Sterilization Solutions,” The Administrators of the Tulane Educational Fund, United States of America, U.S. Pat. No. 10,251,971 B2, (Apr. 9, 2019).
Roy, Chad, Metzinger, Rebecca and Reimers, R., Sep. 9, 2016. “Compositions and Methods for Multipurpose Disinfection and Sterilization Solutions,” The Board of Educators of Tulane University, United States of America, United States and International Provisional Patent Confirmation No. USP201562213964
Schmoll-Hattier, Linda M, Reimers, Robert S. and Bradford, Henry B., 2004. Deactivation of BVacillus anthracis spores using Nok-Out,” a masters paper report to PERC Corporation, Kenner, La.
Thurston, R. V., Russo, R. C., Vinogradov, G. A., 1981. Ammonia toxicity to fishes. effect of pH on the toxicity of the unionized ammonia species. Environmental Science and Technology. 15(7), 837-840.
U.S. Dept. Of Health and Human Service, Office of Disease Prevention and Health Promotion, “Health Care-Associated Infections”, (Jan. 15, 2020) see, https://health.gov/our-work/health-care-quality/health-care-associated-infections (accessed May 21, 2021).
Vital Oxide Solutions, LLC, USEPA Certification for Inactivation of Viruses, Bacteria and Molds (March 2020)
Yang, W. C., 1996. Abiotic factors in biosolids processing that influence pathogen disinfection (nitrous acid and ammonia studies). Master's thesis, Tulane University, New Orleans, La., USA.

1. A composition comprising a stabilized chlorine dioxide; a quaternary ammonium salt; ammonium phosphate; a nonionized ammonia; a buffer, a surfactant, a stabilizer; and water; wherein the composition is configured to be used as a disinfecting solution.

2. (canceled)

3. The composition of claim 1, wherein the stabilized chlorine dioxide comprises an amount ranging from about 0.2% to about 10.0% (w/w).

4. The composition of claim 1, wherein the quaternary ammonium salt comprises a C12 or C14 alkyl chain.

5. The composition of claim 4, wherein the C12-C14-alkyl chain comprises C12-C14-alkyl (ethylbenzyl) dimethyl ammonium chloride.

6. The composition of claim 5, wherein the C12-C14-alkyl (ethylbenzyl) dimethyl ammonium chloride comprises an amount ranging from about 0.1% to about 10% (w/w).

7. The composition of claim 1, wherein the quaternary ammonium salt is not dodecyl dimethyl ammonium chloride, alkyl dimethyl benzyl ammonium chloride or benzalkonium chloride.

8. The composition of claim 1, wherein the ammonium phosphate takes the form of ammonium phosphate (monobasic) [NH₄H₂PO₄] or ammonium phosphate (dibasic) [(NH₄)₂HPO₄] and comprises an amount ranging from about 2.0% to about 20.0% (w/w).

9. (canceled)

10. The composition of claim 1, wherein the ammonium phosphate in the composition having a pH of 7.4 dissociates to produce 1% of non-ionized ammonia.

11. (canceled)

12. The composition of claim 1, wherein the ammonium phosphate in the composition having a pH of 8.4 dissociates to produce 10% of non-ionized ammonia.

13. (canceled)

14. The composition of claim 1, wherein nonionized ammonia comprises an amount ranging from about 0.02% to about 2.0% (w/w).

15-16. (canceled)

17. The composition of claim 1, wherein the stabilizer comprises sodium chloride in a concentration of about 6.5 g/L and potassium chloride in a concentration of about 2.5 g/L.

18. The composition of claim 1, wherein the surfactant comprises ethylenediamine ethoxylated propoxylated polymer in an amount of from about 1 g/L to about 4 g/L.

19. (canceled)

20. (canceled)

21. The composition of claim 124, wherein the composition possesses a disinfectant property of about the six logs against Clostridioides difficile (C. difficile).

22. The composition of claim 1, wherein an article disinfected with the composition retain the disinfectant property for about 2 weeks to 4 months.

23. The composition of claim 22, wherein the article comprises a heating-ventilation-air-conditioning (HVAC) facility, a school, a hospital, a healthcare facility, residential care facilities, child facilities, an adult daycare facility, homes, buildings, airplanes, cruise ships or commercial and industrial establishments.

24. (canceled)

25. (canceled)

27. A composition comprising:
stabilized chlorine in an amount of 0.2% to about 10.0% (w/w);
a quaternary ammonium salt in an amount ranging from about 0.1% to about 10% (w/w);
ammonium phosphate in an amount of about 2.0% to about 20% (w/w);
a nonionized ammonia in an amount of about 0.02% to about 2.0% (w/w);
a buffer comprising sodium bicarbonate to maintain pH between 7.0 to 8.5;
a surfactant comprising ethylenediamine ethoxylated propoxylated polymer in an amount of about 1 g/L to about 4 g/L; and
a stabilizer in an amount of 2 g/L to 10 g/L;
wherein an amount of the non-ionized ammonia is 0.02% to about 12% (w/w).

28. The composition of claim 27, wherein the quaternary ammonium salt is C12-C14-alkyl (ethylbenzyl) dimethyl ammonium chloride.

29. (canceled)

30. The composition of claim 27, wherein pH is maintained at about 7.04 to 8.5.

31. The composition of claim 27, wherein the wherein the composition is applied as a spray, a wipe, a fume, and a fog to disinfect an article.

32. (canceled)

33. A method of disinfection comprising using an environmental disinfecting composition comprising:
(a) stabilized chlorine dioxide solution;
(b) an quaternary ammonium salt being C12-C14-alkyl(ethylbenzyl)dimethylammonium chloride;
(c) ammonium phosphate having a formula of [NH₄H₂PO₄] or [(NH₄)₂HPO₄];
(d) non-ionized ammonia; and
(e) buffer, stabilizer, surfactant;
wherein the C12-C14-alkyl(ethylbenzyl)dimethylammonium chloride is present in an amount ranging from about 0.1% to about 10% (w/w).

34-42. (canceled)
